(19) United States
(12) Patent Application Publication
(10) Pub. No.: US 2026/0339189 A1
(43) Pub. Date: Oct. 29, 2026

(54) CONTROL METHOD FOR PROJECTION DEVICE AND PROJECTION DEVICE

(71) Applicant: Anker Innovations Technology Co., Ltd., Changsha (CN)

(72) Inventors: Huachao Liu, Shenzhen (CN); Qingchun Nie, Shenzhen (CN); Pidong Shen, Shenzhen (CN); Dongjiang Wu, Shenzhen (CN); Yang Zhang, Shenzhen (CN); Hualiang Huang, Shenzhen (CN); Xiao Li, Shenzhen (CN); Ziguang Zhou, Shenzhen (CN); Liang Tan, Shenzhen (CN); Linlang Xie, Shenzhen (CN); Ming Luo, Shenzhen (CN); Peng Chen, Shenzhen (CN); Huajin Huang, Shenzhen (CN)

(21) Appl. No.: 19/654,560

(22) Filed: Apr. 22, 2026

(30) Foreign Application Priority Data
Apr. 23, 2025 (CN) 202510522935.4

(51) Int. Cl. G03B 21/53; G03B 21/14; G06T 7/70

(52) U.S. Cl. CPC G03B 21/53; G03B 21/147; G06T 7/70

(57) ABSTRACT

The present application relates to a control method for a projection device and a projection device. The method includes: controlling a light engine and/or a body to perform adjustment motion in response to a received motion instruction, where the adjustment motion includes at least pitch motion; obtaining planar image data of a to-be-projected area through a camera during the motion; determining a target projection area based on the planar image data when a motion state of the projection device is detected as stopping motion; adjusting a target throw ratio for a projection image based on the target projection area; and correcting the projection image based on the adjusted target throw ratio. The target projection area is determined after the projection device stops motion, then the target throw ratio is adjusted and the projection image is corrected, achieving image correction with the motion of the projection device.

### CROSS-REFERENCE TO RELATED APPLICATION

This application claims priority to Chinese Patent Application No. 2025105229354, filed on Apr. 23, 2025, the entire contents of which are incorporated herein by reference.

### FIELD

The present application relates to the technical field of projection, and in particular, to a control method for a projection device and a projection device.

### BACKGROUND

A projection device, also known as a projecting apparatus or a projector, is an optical instrument that can project images or videos onto a screen for display. With the development of technology, projection devices have been increasingly used in people's daily production, life, and learning.

During the use of projection devices, control operations such as image focusing and keystone correction are usually required to ensure that projection images are clear and presented as rectangles. In practical applications, as the projection device moves, the position of the projection image changes and the image quality is affected accordingly.

In related technologies, projection devices cannot correct images in accordance with their motion, and manual correction is still required.

### SUMMARY

In view of the above technical problems, the present disclosure provides a control method for a projection device and a projection device.

In a first aspect, the present application provides a control method for a projection device. The projection device includes a light engine, a camera, and a body. The light engine and the camera are arranged on the body. The method may include controlling at least one of the light engine or the body to perform an adjustment motion in response to a received motion instruction. The adjustment motion includes at least a pitch motion. The method may include obtaining planar image data of a to-be-projected area through the camera during the motion of the at least one of the light engine or the body. The method may include determining a target projection area based on the planar image data in response to detecting that the adjustment motion has stopped (or when a motion state of the projection device is detected as a stopping motion). The method may include adjusting a target throw ratio for a projection image based on the target projection area. The method may further include correcting the projection image based on the adjusted target throw ratio.

In a second aspect, the present application provides a projection device. The projection device may comprise a light engine, a camera, a body, a pan-tilt mechanism, and a motion state sensor. The pan-tilt mechanism may be rotatably connected to the light engine and configured to drive the light engine to perform an adjustment motion. The adjustment motion includes at least a pitch motion. Alternatively, the pan-tilt mechanism may be rotatably connected to the body and configured to drive the body to perform the adjustment motion.

The motion state sensor may be connected to at least one of the light engine or the pan-tilt mechanism to obtain a motion state of the projection device. The camera may be arranged on the body and configured to obtain planar image data of a to-be-projected area. The projection device may be configured to determine a target projection area based on the planar image data when the motion state is detected as a stopping motion, to adjust a target throw ratio for a projection image based on the target projection area, and to correct the projection image based on the adjusted target throw ratio.

In the control method for the projection device and the projection device, the light engine and/or the body may be controlled to perform adjustment motion in response to the received motion instruction. The planar image data of the to-be-projected area may be obtained through the camera during the motion of the light engine and/or the body. When it is detected that the projection device has stopped moving, the target projection area may be determined based on the planar image data, and the target throw ratio may be adjusted for the projection image based on the target projection area. The projection image may be corrected based on the adjusted target throw ratio. The adjustment motion may include at least a pitch motion. In the above method, the target projection area may be determined by obtaining the planar image data of the to-be-projected area after the projection device stops moving. Then, the target throw ratio may be adjusted, and the projection image may be corrected based on the adjusted target throw ratio. This may enable image correction to follow the motion/movement of the projection device, thereby improving the display effect/quality of the projection image.

### BRIEF DESCRIPTION OF THE DRAWINGS

Accompanying drawings, which are incorporated in and constitute a part of this specification, illustrate examples according to the disclosure, which together with the specification serve to explain principles of the disclosure.

In order to more clearly illustrate technical solutions in examples of the present disclosure or the related art, drawings that need to be used in description of the examples are briefly introduced below, and it will be apparent to those of ordinary skill in the art that the drawings in the following description are only some examples of the disclosure, and other drawings can be obtained in accordance with these drawings without inventive work.

One or more examples are illustrated by figures in the corresponding drawings, which does not constitute a limitation of the examples. Elements with the same reference numerals in the drawings represent similar elements, and the drawings do not constitute scale limitation unless otherwise specified.

FIG. 1 is an internal structural diagram of a projection device;

FIG. 2 is a schematic flowchart of a control method for a projection device;

FIG. 3 is a schematic flowchart of correcting a projection image based on an adjusted target throw ratio;

FIG. 4 is a schematic flowchart illustrating that a focus drive mechanism drives the focus lens set to move;

FIG. 5 is a schematic flowchart of determining that the focus lens set has moved to the target focus position;

FIG. 6 is a schematic flowchart illustrating that a zoom drive mechanism drives a zoom lens set to move;

FIG. 7 is a schematic flowchart of determining that the zoom lens set has moved to a target zoom position;

FIG. 8 is a schematic flowchart of performing focus compensation on a projection image;

FIG. 9 is a schematic flowchart of obtaining a focus compensation value;

FIG. 10 is a schematic flowchart of obtaining a target projection image;

FIG. 11 is a schematic flowchart of forming the target projection image on a target projection plane;

FIG. 12 is a structural block diagram of a projection device;

FIG. 13 is a schematic structural diagram of a projection lens;

FIG. 14 is a schematic structural diagram of an optical lens set; and

FIG. 15 is a structural block diagram of a control apparatus for a projection device.

### DETAILED DESCRIPTION

In order to make the objectives, technical solutions, and advantages of the present application clearer, the present application will be further described in detail below in conjunction with the accompanying drawings and examples. It should be understood that the specific examples described herein are merely used to explain the present application, but not to limit the present application.

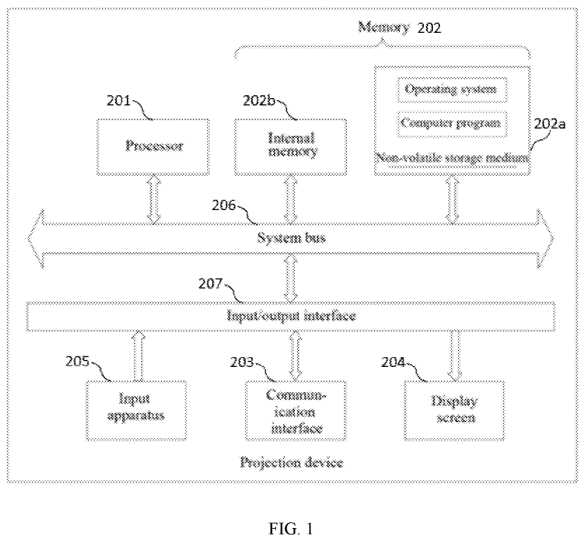

A control method for a projection device, provided by the examples of the present application, may be applied to a projection device shown in FIG. 1. The projection device includes a processor 201, a memory 202, a communication interface 203, a display screen 204, and an input apparatus 205 connected through a system bus 206 and/or an input/output interface 207. The processor 201 of the projection device is configured to provide computing and control capabilities. The memory 202 of the projection device includes a non-volatile storage medium 202a and an internal memory 202b. The non-volatile storage medium stores an operating system and a computer program. The internal memory provides an environment for running the operating system and the computer program in the non-volatile storage medium. The communication interface 203 of the projection device is configured for wired or wireless communication with an external terminal. The wireless communication may be implemented through WIFI, a mobile cellular network, an NFC (Near Field Communication), or other technologies. The computer program is executed by the processor 201 to implement the control method for the projection device. The display screen 204 of the projection device may be a liquid crystal display screen or an electronic ink display screen. The input apparatus 205 of the projection device may be a touch layer covering the display screen 204, or a button, trackball or touchpad arranged on a housing of the projection device, or an external keyboard, touchpad or mouse.

A person skilled in the art may understand that the structure shown in FIG. 1 is merely a block diagram of a partial structure related to the solution of the present application, and does not constitute a limitation on the computer device to which the solution of the present application is applied. The specific computer device may include more or fewer parts than shown in the figure, or combine some parts, or have a different arrangement of parts.

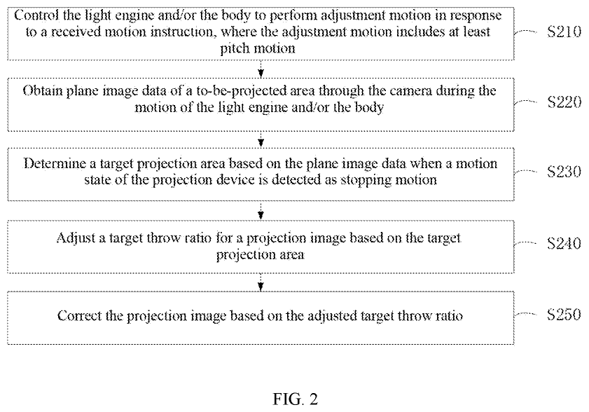

As shown in FIG. 2, a control method for a projection device is provided. The projection device may include a light engine (or optical engine), a camera, and a body (or device body). The light engine and the camera may be arranged on/at/in the body. Taking the application of this method to the projection device in FIG. 1 as an example, the method includes the following steps:

S210: Control the light engine and/or the body to perform an adjustment motion in response to a received motion instruction. The adjustment motion includes at least a pitch motion. A pitch motion may be, for example, a pitch rotation about a horizontal axis.

The light engine is a collection of optical components used in the projection device to form a projection image. For example, the light engine includes a series of optical components such as a lens, a light source, and a digital micro-mirror device (DMD). The adjustment motion may include motion in different directions, and the pitch motion is vertical motion. The adjustment motion may further include horizontal motion. A horizontal plane and a vertical plane form a certain angle. For example, the horizontal plane is parallel to a placement plane of the projection device and perpendicular to the vertical plane.

It should be noted that the light engines of some projection devices support motion and can be used to implement optical zooming and change throw ratios; and the bodies of some projection devices support motion and can be used to adjust body poses and change throw distances and/or projection angles.

In an example, the projection device can receive the motion instruction for the light engine and/or the body, and in response to the motion instruction, correspondingly control the light engine and/or the body to perform the adjustment motion indicated by the motion instruction.

For example, in response to the motion instruction for the light engine, the projection device correspondingly controls the light engine to perform the adjustment motion indicated by the motion instruction; or in response to the motion instruction for the body, the projection device correspondingly controls the body to perform the adjustment motion indicated by the motion instruction.

S220: Obtain planar image data of a to-be-projected area through the camera during the motion of the light engine and/or the body. The planar image data of a to-be-projected area may refer to image data of a projection surface.

The planar image data of the to-be-projected area is used to represent a planar image including the to-be-projected area.

In an example, the projection device can capture the planar image of the to-be-projected area through the camera during the motion of the light engine and/or the body, as the planar image data of the to-be-projected area.

S230: Determine a target projection area based on the planar image data when a motion state of the projection device is detected as a stopping motion (or in response to detecting that the adjustment motion has stopped). The stopping motion refers to a stopped-motion state (or a stop state) in which motion has stopped.

The “motion state of the projection device is detected as stopping motion” represents that the entire projection device stops motion, that is, both the light engine and the body of the projection device stop motion.

In an example, the projection device can detect respective motion states of the light engine and the body, to determine an overall motion state of the projection device based on the respective motion states. When both the light engine and the body stop motion, the motion state of the projection device is detected as a stopping motion. When the motion state of the projection device is detected as the stopping motion, the projection device can determine a screen area in the planar image data obtained in the stop state as the target projection area, or determine an obstacle avoidance area in the planar image data as the target projection area, or determine an area where the screen area overlaps with the obstacle avoidance area in the planar image data as the target projection area.

S240: Adjust a target throw ratio for a projection image based on the target projection area.

As the projection device moves, the target projection area available for projection in the to-be-projected area changes, and a throw ratio of the projection image needs to be adjusted accordingly to adapt to the target projection area.

In an example, the projection device determines, based on the target projection area obtained after stopping motion, a throw ratio adapted to the target projection area as a target throw ratio, and adjusts the generated projection image to achieve the target throw ratio.

S250: Correct the projection image based on the adjusted target throw ratio.

In an example, the correction of the projection image includes at least one of focusing, zooming, and keystone correction.

The focusing is used to sharpen the projection image to improve the projection quality; the zooming is used to change the size of the projection image to meet scenario requirements; and the keystone correction is used to adjust the shape of the projection image to present the projection image as a rectangle.

In an example, the projection device can adjust the size of the projection image by zooming based on the target throw ratio, so that the projection image reaches the target throw ratio; and the projection device can adjust the clarity of the projection image by focusing based on the target throw ratio, so that the projection image meets clarity requirements.

In the examples of the present application, the light engine and/or the body are controlled to perform adjustment motion in response to the received motion instruction. The planar image data of the to-be-projected area is obtained through the camera during the motion of the light engine and/or the body. The target projection area is determined based on the planar image data when the motion state of the projection device is detected as stopping motion. The target throw ratio is adjusted for the projection image based on the target projection area, and the projection image is corrected based on the adjusted target throw ratio. The adjustment motion includes at least pitch motion. In the above method, the target projection area is determined by obtaining the planar image data of the to-be-projected area after the projection device stops motion, then the target throw ratio is adjusted, and the projection image is corrected based on the adjusted target throw ratio, achieving image correction with the motion of the projection device, and improving the display effect of the projection image.

In order to maximize the projection image, in one example, S230 of determining the target projection area based on the planar image data includes:

determining a maximum projectable area based on the planar image data and determining the maximum projectable area as the target projection area. The maximum projectable area is one of a screen and an obstacle avoidance area.

In an example, after obtaining the planar image data of the to-be-projected area, the projection device can determine the screen in the planar image data and use the screen as the maximum projectable area, or determine the obstacle avoidance area in the planar image data and use the obstacle avoidance area as the maximum projectable area, and then determine the maximum projectable area as the target projection area.

When the maximum projectable area is the screen, S240 of adjusting a target throw ratio for a projection image based on the target projection area includes:

using a preset target ratio of the projection image to the screen as the target throw ratio, and adjusting the projection image within an area of the screen based on the target throw ratio.

When the maximum projectable area is the obstacle avoidance area, an inscribed rectangle of the maximum projectable area is used as the target projection area, and S240 of adjusting a target throw ratio for a projection image based on the target projection area includes:

using a preset target ratio of the projection image to the inscribed rectangle as the target throw ratio, and adjusting the projection image within an area of the inscribed rectangle based on the target throw ratio.

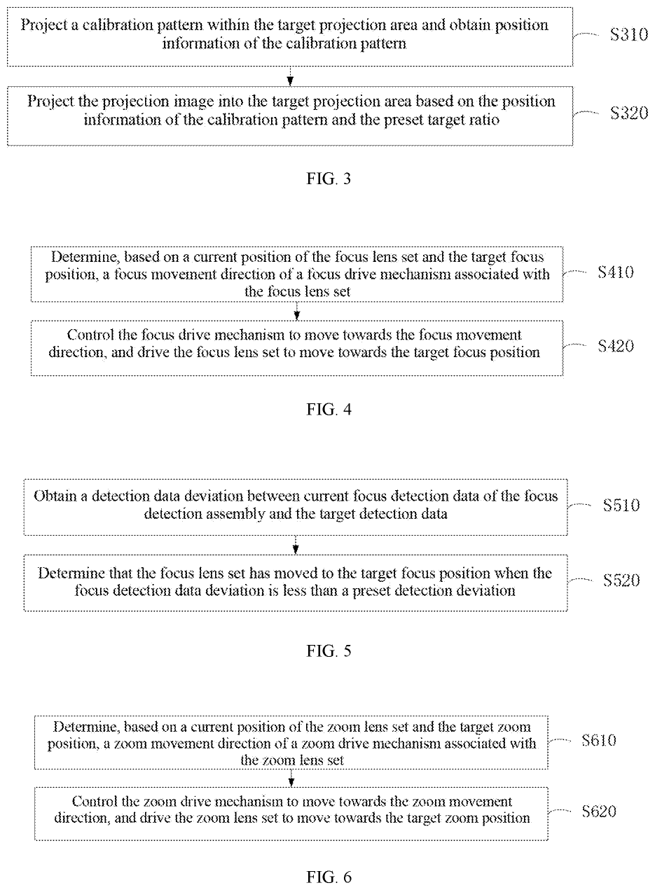

The adjusted target throw ratio is the preset target ratio. As shown in FIG. 3, S250 of correcting the projection image based on the adjusted target throw ratio includes:

S310: Project a calibration pattern within the target projection area and obtain position information of the calibration pattern.

The calibration pattern is a pattern that calibrates a position of the formed projection image in the target projection area.

In an example, the projection device can use calibration as a content of the projection image to project the calibration pattern within the target projection area, and then obtain the position information of the calibration pattern in the target projection area.

S320: Project the projection image into the target projection area based on the position information of the calibration pattern and the preset target ratio.

In an example, after obtaining the position information of the calibration pattern and the preset target ratio, the projection device can project the projection image into the target projection area, adjust the throw ratio of the projection image to achieve the target ratio, and adjust the position of the projection image to reach the position information of the calibration pattern.

In the examples of the present application, the calibration pattern is projected within the target projection area. The position information of the calibration pattern is obtained, and then the projection image is projected into the target projection area based on the position information of the calibration pattern and the target ratio. In the above method, the projection image is projected into the target projection area based on the position information of the calibration pattern and the target ratio, achieving position and size correction of the projection image, and correspondingly improving the matching degree between the projection image and the application scenario, thereby improving the projection display effect.

Before S210 of controlling the light engine and/or the body to perform adjustment motion in response to a received motion instruction, the method further includes:

adjusting a throw ratio of the projection device to a maximum size achievable by a current projection image, and projecting the current projection image to the to-be-projected area.

In an example, the projection device, when powered on for the first time after a power outage (i.e., turned on) or entering an awakened state, can adjust its current throw ratio to the maximum size achievable by the current projection image, and then project the current projection image that has reached the maximum size onto the to-be-projected area, so as to obtain information of the to-be-projected area within a maximum range during the adjustment motion. A maximum range of projectable area can be analyzed from the planar image data of a to-be-projected plane obtained by the camera.

In the examples of the present application, prior to the response to the received motion instruction, the throw ratio of the projection device is adjusted to the maximum size achievable by the current projection image, and the current projection image is projected to the to-be-projected area. In the above method, before performing adjustment motion in response to the motion instruction, the projection device first adjusts its throw ratio so that the current projection image achieves the maximum size, and then projects the current projection image to the to-be-projected area, so as to adjust from the projection image with the maximum size subsequently.

The light engine includes a focus lens set and a zoom lens set. S250 of correcting the projection image based on the adjusted target throw ratio includes:

controlling the focus lens set to move to a target focus position corresponding to the target throw ratio based on a preset focus mapping relationship between a throw ratio and a focus position; and/or controlling the zoom lens set to move to a target zoom position corresponding to the target throw ratio based on a preset zoom mapping relationship between a throw ratio and a zoom position.

The focus lens set is configured to change the focal length of a lens, achieving clear focusing of the projection image. The zoom lens set is configured to change the throw ratio of the projection device, thereby adjusting the size of the projection image. The target throw ratio is a throw ratio desired to be achieved by the projection device. The focus position is used to represent a position of the focus lens set, while the zoom position is used to represent a position of the zoom lens set.

In an example, the projection device can read the preset focus mapping relationship between the throw ratio and the focus position to determine the target focus position corresponding to the target throw ratio, and control the focus lens set to move to the target focus position.

In an example, the projection device can read the preset zoom mapping relationship between the throw ratio and the zoom position to determine the target zoom position corresponding to the target throw ratio, and control the zoom lens set to move to the target zoom position.

In an example, the projection device can read the preset focus mapping relationship between the throw ratio and the focus position, and the preset zoom mapping relationship between the throw ratio and the zoom position, to determine the target focus position and the target zoom position corresponding to the target throw ratio respectively, and control the focus lens set to move to the target focus position and the zoom lens set to move to the target zoom position respectively.

In the examples of the present application, the light engine includes the focus lens set and the zoom lens set, and the projection device controls the focus lens set to move to the target focus position corresponding to the target throw ratio based on the preset focus mapping relationship between the throw ratio and the focus position, and/or controls the zoom lens set to move to the target zoom position corresponding to the target throw ratio based on the preset zoom mapping relationship between the throw ratio and the zoom position. In the above method, based on the target throw ratio after the projection device stops motion, the projection image is automatically focused/zoomed by using the preset focus mapping relationship and/or zoom mapping relationship, thereby shortening the completion time of focusing/zooming. Meanwhile, because the focus position obtained based on the throw ratio during focusing can reflect the impact of the throw ratio on image display in the focusing effect on the image, the focusing is more accurate, a precise focusing effect is achieved, and the image is clearer than an image when the impact of the throw ratio is not considered. In this solution, focusing and zooming can be performed simultaneously, or zooming can be completed first before focusing. In addition, focusing can also be completed before zooming. The target throw ratio is calculated from an optimal throw ratio of the target projection area.

The focus mapping relationship can be constructed in various ways. The focus mapping relationship can be simulated based on an optical simulation model for the projection device, including the following steps:

Input simulation parameter conditions of the projection device into the optical simulation model for the projection device for imaging simulation, to obtain a corresponding relationship between a throw ratio and a target object distance of the projection device at different throw distances. The target object distance represents an object distance of the projection device, at which a projection image meets quality requirements.

In an example, the simulation parameter conditions of the projection device include a throw ratio, an object distance, and a throw distance. Different throw ratios, object distances, and throw distances are input into the optical simulation model. Imaging simulation is performed through a preset simulation method, and imaging qualities of the projection image under different throw ratios, object distances, and throw distances are determined through a contrast detection algorithm.

For example, the optical simulation model can accurately describe parameters such as curvature, thickness, material, and lens spacing of each lens in the projection device, and the preset simulation method may include ray tracing and the like. The imaging quality may be a clarity of the projection image, and “a projection image meets quality requirements” may be that the clarity of the projection image meets preset requirements. The contrast detection algorithm may include a gradient-based algorithm, a histogram-based algorithm, or a wavelet-based algorithm. The imaging quality of the projection image can alternatively be adjusted through a transfer function. The present application does not limit to these examples.

In an example, different throw distances can be obtained, and after one throw distance is obtained, the throw ratio and the object distance are continuously adjusted to determine target object distances corresponding to different throw ratios at the throw distance based on the imaging quality.

Construct a corresponding relationship between a throw ratio and a number of steps of a focus motor or magnetic encoder data at different throw distances as the focus mapping relationship based on the corresponding relationship between the object distance of the projection device and the number of steps of the focus motor or the magnetic encoder data, as well as the corresponding relationship between the throw ratio and the target object distance at different throw distances.

In an example, the corresponding relationship between the object distance of the projection device and the number of steps of the focus motor or between the object distance of the projection device and the magnetic encoder data can be determined through a pre-built mathematical model or mapping table. After the object distance of the projection device is determined, a corresponding number of steps of the focus motor or a corresponding magnetic encoder data can be determined based on the mathematical model or mapping table.

In an example, at different throw distances, by combining the one-to-one corresponding relationship between throw ratios and target object distances and the one-to-one corresponding relationship between the object distance of the projection device and the number of steps of the focus motor or the one-to-one corresponding relationship between the object distance of the projection device and the magnetic encoder data, with the target object distance as an intermediate bridge, the corresponding relationship between the throw ratio and the number of steps of the focus motor or between the throw ratio and the magnetic encoder data can be determined at different throw distances, thereby determining the focus mapping relationship.

For example, the focus mapping relationship may include corresponding relationships between different throw ratios and focus positions at different throw distances. Each focus position corresponds to a group of parameters, and the parameters include at least one of a target object distance, the number of steps of the focus motor, and magnetic encoder data.

The focus mapping relationship can alternatively be obtained based on factory calibration, including the following steps:

Obtain, at each of multiple throw distances, an image quality curve of projection image quality varying within a range of the focus motor in the projection device under different throw ratios.

In an example, for each throw distance, a throw ratio of the projection device is obtained first, and then the focus motor is adjusted to rotate. Each time the focus motor rotates, a projection image quality corresponding to a current number of steps of the focus motor is obtained. By continuously adjusting the steps of the focus motor, the image quality curve of projection image quality varying within the range of the focus motor under the current throw ratio can be obtained.

For example, when the throw distance is 2 meters and the throw ratio is 0.9, the focus motor is adjusted step by step from a leftmost end to a rightmost end of a structure, or from a rightmost end to a leftmost end of a structure, to obtain an image quality curve of projection image quality varying within the range of the focus motor.

In an example, the throw ratio of the projection device is adjusted at one throw distance, and then the above steps are repeated to obtain a curve of multiple image qualities at a fixed throw distance and different throw ratios. For example, there are m throw distances and n throw ratios. Then, an m×n image quality curve can be obtained. The horizontal axis of the image quality curve can represent the number of steps of the focus motor, and the vertical axis can represent the clarity of the projection image.

Determine, based on the image quality curve, a number of steps of the focus motor that meets quality requirements.

In an example, a peak point in the image quality curve can be first determined, and a horizontal axis position corresponding to the peak point can be the number of steps of the focus motor that meets quality requirements. For example, values in the image quality curve can be compared to determine a maximum value point, and the number of steps of the focus motor that meets quality requirements is determined based on a horizontal axis position corresponding to the maximum value point. Alternatively, when there are multiple local peaks in the image quality curve, the magnitudes of the peaks are compared, and the number of steps of the focus motor that meets quality requirements is determined based on a horizontal axis position corresponding to a maximum peak.

Construct the focus mapping relationship based on the number of steps of the focus motor corresponding to each throw distance and throw ratio.

In an example, for each image quality curve, a group of throw distances, throw ratios, and steps of the focus motor that meet quality requirements, corresponding to the image quality curve, can be determined, and the focus mapping relationship can be determined based on multiple groups of throw distances, throw ratios, and steps of the focus motor.

In an example, after a group of throw distances, throw ratios, and steps of the focus motor is determined, a corresponding object distance can be further determined based on the relationship between the number of steps of the focus motor and the object distance.

In another optional example, there is a correlation between the steps of the focus motor and the magnetic encoder data. Therefore, for each throw distance, the image quality curve of projection image quality varying within the range of the focus motor under different throw ratios can be obtained. At this point, the horizontal axis of the image quality curve represents the magnetic encoder data, and the vertical axis represents the clarity of the projection image. By the same steps as the determining step and constructing step, multiple groups of throw distances, throw ratios, and magnetic encoder data can be determined, and then the focus mapping relationship can be determined based on the multiple groups of throw distances, throw ratios, and magnetic encoder data.

The zoom mapping relationship can be constructed through the following steps:

Obtain a calibration relationship between multiple throw ratios formed by the projection device at a reference throw distance and magnetic encoder data.

The reference throw distance may be a straight-line distance between the lens of the projection device and the projection screen or projection surface when the zoom mapping relationship is constructed. The reference throw distance may be a fixed value within a range of 1 m to 4 m. For example, the reference throw distance may be 2 m.

In an example, the projection device can project a projection image at the reference throw distance, obtain a width of the projection image through an image sensor, determine a throw ratio corresponding to the width of the projection image based on a ratio of the reference throw distance to the width of the projection image, and read magnetic encoder data corresponding to a current zoom magnetic encoder. Through the above method, the calibration relationship between a throw ratio and a corresponding magnetic encoder data can be determined. The above steps are repeated. The projection device determines multiple different throw ratios by adjusting the width of the projection image, and determines magnetic encoder data of the zoom magnetic encoder under each throw ratio, thereby obtaining the calibration relationship between multiple throw ratios and magnetic encoder data.

Determine a magnetic encoder position corresponding to each throw ratio based on the calibration relationship between each throw ratio and magnetic encoder data.

For each throw ratio, the projection device can determine the magnetic encoder position based on the magnetic encoder data corresponding to the throw ratio in the calibration relationship.

Construct the zoom mapping relationship based on each throw ratio and the magnetic encoder position corresponding to each throw ratio.

In an example, after each throw ratio and the magnetic encoder position corresponding to each throw ratio are determined, the projection device may determine the zoom mapping relationship based on the corresponding relationship between the throw ratio and the magnetic encoder position.

For focusing control, in one example, as shown in FIG. 4, the above step of controlling the focus lens set to move to a target focus position corresponding to the target throw ratio includes:

S410: Determine, based on a current position of the focus lens set and the target focus position, a focus movement direction of a focus drive mechanism associated with the focus lens set.

The focus drive mechanism associated with the focus lens set is configured to drive the focus lens set to move. For example, the focus drive mechanism associated with the focus lens set may be a focus motor. The projection device can drive the focus lens set to move by adjusting the number of steps of the focus motor.

In an example, the projection device can determine, based on the current position of the focus lens set, whether the target focus position to be entered is located on a side of the current position near a movement starting point of the focus lens set, or on a side near a movement end point of the focus lens set, thereby determining a movement direction of the focus drive mechanism as the focus movement direction.

For example, when the target focus position is located on the side of the current position near the movement starting point, the projection device can determine that the focus movement direction is a positive movement direction, such as a clockwise movement direction of the focus motor; and when the target focus position is located on the side of the current position near the movement end point, the projection device can determine that the focus movement direction is a negative movement direction, such as a counterclockwise movement direction of the focus motor.

S420: Control the focus drive mechanism to move towards the focus movement direction, and drive the focus lens set to move towards the target focus position.

In an example, after obtaining the focus movement direction, the projection device can control the focus drive mechanism to move towards the focus movement direction, so as to drive the focus lens set to move towards the target focus position under the movement of the focus drive mechanism, until the focus lens set moves to the target focus position corresponding to the target throw ratio.

In the examples of the present application, the focus movement direction of the focus drive mechanism associated with the focus lens set is determined based on the current position of the focus lens set and the target focus position. The focus drive mechanism is controlled to move towards the focus movement direction, and the focus lens set is driven to move towards the target focus position. In the above method, the focus movement direction is determined based on the current position of the focus lens set and the target focus position to be entered, and the movement of the focus lens set is controlled based on the focus movement direction, achieving focusing control with a clear direction of movement and improving focusing reliability.

The focus drive mechanism may be a motor. In the presence of a gap during structural coordination, when the motor drives the focus lens set to move, there may be certain idle travel if the movement direction needs to be adjusted (such as from the positive movement direction to the negative movement direction). Although the motor rotates a few steps, the focus lens set does not actually move. In this solution, the rotation of the motor is not used as a calculation parameter for the movement of the focus lens set. Instead, focus detection data detected by the zoom magnetic encoder is used as the basis for calculating the position of the focus lens set, and can reflect true movement of the focus lens set, thereby eliminating the influence of the idle travel on determining the focus position, and making the focusing effect of an image clearer.

The light engine further includes a focus detection assembly, and the target focus position is a position of the focus lens set when the focus detection assembly detects target detection data. In one example, as shown in FIG. 5, the above step of controlling the focus lens set to move to a target focus position corresponding to the target throw ratio includes:

S510: Obtain a detection data deviation between current focus detection data of the focus detection assembly and the target detection data.

In an example, the projection device can obtain the current focus detection data of the focus detection assembly and obtain the focus detection data deviation between the current focus detection data and the target detection data.

For example, the projection device can obtain focus detection data of the focus detection assembly in real time or periodically, and use the focus detection data obtained each time as the current focus detection data.

S520: Determine that the focus lens set has moved to the target focus position when the focus detection data deviation is less than a preset detection deviation.

In an example, after obtaining the focus detection data deviation, the projection device can compare the focus detection data deviation with the preset detection deviation, and determine that the focus lens set has moved to the target focus position when the focus detection data deviation is less than the preset detection deviation.

For example, the preset detection deviation is less than a detection data variation caused by movement of half of the depth of focus of the focus lens set.

In an optional example, when the focus detection data deviation is greater than or equal to the preset detection deviation, the projection device can continue to drive the focus lens set to move through the focus drive mechanism, so as to obtain a focus detection data deviation based on new current focus detection data until the focus detection data deviation is less than the preset detection deviation.

For example, the focus detection assembly includes a tunnel magneto resistance (TMR) sensor. Correspondingly, the focus detection data is a TMR value.

In the examples of the present application, the light engine further includes the focus detection assembly. The target focus position is the position of the focus lens set when the focus detection assembly detects the target detection data. The detection data deviation between the current focus detection data of the focus detection assembly and the target detection data is determined, and it is determined that the focus lens set has entered a position area corresponding to the target focus position when the focus detection data deviation is less than the preset detection deviation. In the above method, the focus detection data of the focus detection assembly is directly related to the position of the focus lens set, to accurately reflect the position of the focus lens set. Therefore, whether the focus lens set has moved to the target focus position is determined through the data deviation between the current focus detection data of the focus detection assembly and the target detection data (that the focus lens set correspondingly reaches the target focus position), to improve the accuracy and efficiency of focusing control.

For zooming control, in one example, as shown in FIG. 6, the above step of controlling the zoom lens set to move to a target zoom position corresponding to the target throw ratio includes:

S610: Determine, based on a current position of the zoom lens set and the target zoom position, a zoom movement direction of a zoom drive mechanism associated with the zoom lens set.

The zoom drive mechanism associated with the zoom lens set is configured to drive the zoom lens set to move. For example, the zoom drive mechanism associated with the zoom lens set may be a zoom motor. The projection device can drive the zoom lens set to move by adjusting the number of steps of the zoom motor.

In an example, the projection device can determine, based on the current position of the zoom lens set, whether the target zoom position to be entered is located on a side of the current position near a movement starting point of the zoom lens set, or on a side near a movement end point of the zoom lens set, thereby determining a movement direction of the zoom drive mechanism as the zoom movement direction.

For example, when the target zoom position is located on the side of the current position near the movement starting point, the projection device can determine that the zoom movement direction is a positive movement direction, such as a clockwise movement direction of the zoom motor; and when the target zoom position is located on the side of the current position near the movement end point, the projection device can determine that the zoom movement direction is a negative movement direction, such as a counterclockwise movement direction of the zoom motor.

S620: Control the zoom drive mechanism to move towards the zoom movement direction, and drive the zoom lens set to move towards the target zoom position.

In an example, after obtaining the zoom movement direction, the projection device can control the zoom drive mechanism to move towards the zoom movement direction, so as to drive the zoom lens set to move towards the target zoom position under the movement of the zoom drive mechanism, until the zoom lens set moves to the target zoom position corresponding to the target throw ratio.

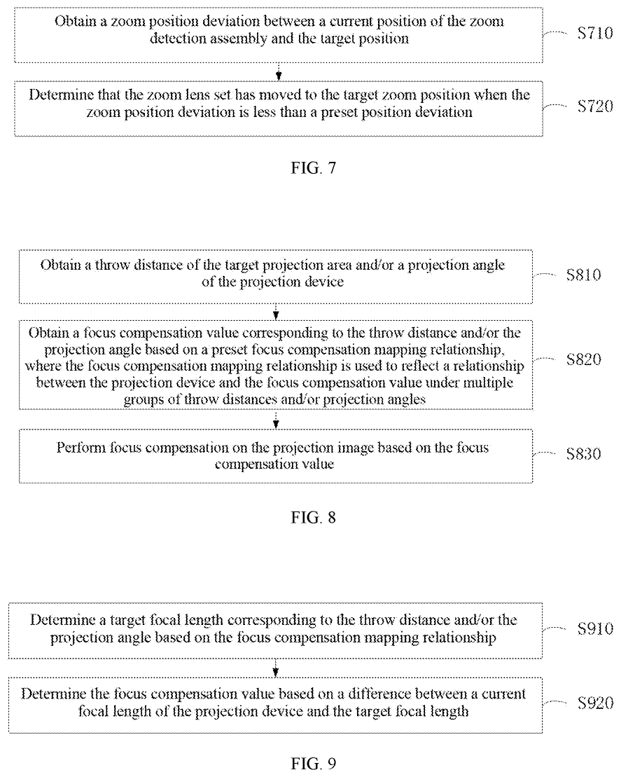

The light engine further includes a zoom detection assembly, and the target zoom position is a position of the zoom lens set when the zoom detection assembly reaches a target position. In one example, as shown in FIG. 7, the above step of controlling the zoom lens set to move to a target zoom position corresponding to the target throw ratio includes:

S710: Obtain a zoom position deviation between a current position of the zoom detection assembly and the target position.

The zoom detection assembly includes a TMR and a magnet segment group, and the position of the zoom detection assembly is used to represent a position of the TMR on the magnet segment group.

In an example, the projection device can obtain the current position of the zoom detection assembly and obtain the zoom position deviation between the current position and the target position.

For example, the projection device can obtain the position of the TMR on the magnet segment group in the focus detection assembly in real time or periodically, and designate the position obtained each time as the current position.

S720: Determine that the zoom lens set has moved to the target zoom position when the zoom position deviation is less than a preset position deviation.

In an example, after obtaining the zoom position deviation, the projection device can compare the zoom position deviation with the preset position deviation, and determine that the zoom lens set has moved to the target zoom position when the zoom position deviation is less than the preset position deviation.

In an optional example, when the position deviation is greater than or equal to the preset position deviation, the projection device can continue to drive the zoom lens set to move through the zoom drive mechanism, so as to obtain a zoom position deviation based on a new current position until the zoom position deviation is less than the preset position deviation.

In the examples of the present application, the light engine further includes the zoom detection assembly. The target zoom position is the position of the zoom lens set when the zoom detection assembly reaches the target position. The zoom position deviation between the current position of the zoom detection assembly and the target position is obtained, and it is determined that the zoom lens set has moved to the target zoom position when the zoom position deviation is less than the preset position deviation. In the above method, the position of the zoom detection assembly is directly related to the position of the zoom lens set, to accurately reflect the position of the zoom lens set. Therefore, whether the zoom lens set has moved to the target zoom position is determined through the position deviation between the current position of the zoom detection assembly and the target position (that the zoom lens set correspondingly reaches the target zoom position), to improve the accuracy and efficiency of zooming control.

After the image correction, further focus compensation can be performed on the projection image. On this basis, in one example, as shown in FIG. 8, after S250 of correcting the projection image based on the adjusted target throw ratio, the method further includes:

S810: Obtain a throw distance of the target projection area and/or a projection angle of the projection device.

The throw distance of the target projection area is used to represent a distance between the light engine and a plane where the target projection area is located.

In one example, the projection angle is an angular deviation between an optical axis of the light engine in the projection device and a virtual optical axis of the projection image. For example, the projection angle is obtained based on at least one of a side projection angle, a pitch angle, and a roll angle of the projection device. The throw distance and the projection angle both belong to pose information of the projection device.

In an example, the projection device can detect the throw distance between the light engine and the target projection area through a distance sensor, and obtain the angular deviation between the optical axis of the light engine and the virtual optical axis of the projection image through an attitude sensor as the projection angle.

S820: Obtain a focus compensation value corresponding to the throw distance and/or the projection angle based on a preset focus compensation mapping relationship. The focus compensation mapping relationship is used to reflect (or defines) a relationship (e.g., correspondence) between the focus compensation value and at least one of throw distance or projection angle for multiple groups of throw distances and/or projection angles.

The focus compensation value is used to represent a variation in focal length.

In an example, the projection device can read the preset focus compensation mapping relationship to determine the focus compensation value corresponding to the throw distance and the projection angle.

S830: Perform focus compensation on the projection image based on the focus compensation value.

In an example, after obtaining the focus compensation value, the projection device can adjust its focal length based on the focus compensation value, so that the variation in focal length of the projection device reaches the focus compensation value, achieving focus compensation for the projection image.

For example, the focus compensation mapping relationship is a mapping relationship calibrated under non-frontal projection conditions of the projection device. The projection device can determine the focus compensation value under the non-frontal projection conditions based on the focus compensation mapping relationship, and perform focus compensation under the non-frontal projection conditions on the projection image of the projection device based on the focus compensation value.

In another implementation, after completing obstacle avoidance and keystone correction, the projection image may be offset relative to the optical axis, and there may be an angular deviation of the projection image relative to the optical axis of the light engine, resulting in inconsistent imaging clarity in different areas of the projection image. For example, the side closer to the optical axis may be clearer than the side farther from the optical axis. In this solution, the offset angle of the optical axis of the light engine relative to a center of the projection image is analyzed by image analysis to obtain the projection angle, and focus compensation is performed based on the projection angle. The image analysis can be based on an image obtained by the image sensor during keystone correction or throw ratio adjustment, or the image can be re-obtained after the throw ratio adjustment or keystone correction is completed. In other examples, the projection angle can be obtained based on at least one of a side projection angle, a pitch angle, and a roll angle detected by an attitude sensor in the projection device, such as based on a conversion formula or calibration mapping relationship. In this way, the processor can obtain the throw distance of the target projection area and/or the projection angle of the projection device.

In the examples of the present application, the throw distance of the target projection area and/or the projection angle of the projection device are obtained, the focus compensation value corresponding to the throw distance and/or the projection angle is obtained based on the preset focus compensation mapping relationship, and focus compensation is performed on the projection image based on the focus compensation value. The focus compensation mapping relationship is used to represent the relationship between the projection device and the focus compensation value under multiple groups of throw distances and/or projection angles. In the above method, when the projection device changes only in distance, the focus compensation value is determined based on the throw distance and the focus compensation mapping relationship. When the projection device changes only the projection angle, the focus compensation value is determined based on the projection angle and the focus mapping relationship. When both the throw distance and the projection angle change, the focus compensation value is determined based on the projection angle, the throw distance, and the focus mapping relationship. The focus mapping relationship may be a mapping relationship table between the calibrated throw distance and/or projection angle and the focus compensation value, or a conversion formula between the throw distance and/or projection angle and the focus compensation value.

The focus compensation value can be obtained based on a current focal length of the projection device and a target focal length desired to be achieved by the projection device. In one example, as shown in FIG. 9, S820 of obtaining a focus compensation value corresponding to the throw distance and/or the projection angle based on a preset focus compensation mapping relationship includes:

S910: Determine a target focal length corresponding to the throw distance and/or the projection angle based on the focus compensation mapping relationship.

The focus compensation mapping relationship represents a mapping relationship among a throw distance, a projection angle, and a focal length of the projection device, or a mapping relationship between a throw distance and a focal length of the projection device, or a mapping relationship between a projection angle and a focal length of the projection device.

In an example, the projection device can determine a focal length of the projection device corresponding to the throw distance and/or the projection angle based on the focus compensation mapping relationship, as the target focal length desired to be achieved by the projection device.

S920: Determine the focus compensation value based on a difference between a current focal length of the projection device and the target focal length.

In an example, after obtaining the target focal length, the projection device can read its current focal length, obtain the difference between the target focal length and the current focal length, and use the difference as the focus compensation value.

In the examples of the present application, the target focal length corresponding to the throw distance and/or the projection angle is determined based on the focus compensation mapping relationship, and the focus compensation value is determined based on the difference between the current focal length of the projection device and the target focal length. In the above method, the target focal length desired to be achieved after the projection device stops motion is determined based on the focus compensation mapping relationship, and the variation in focal length is determined based on the current focal length and the target focal length as the focus compensation value to quickly locate the focus compensation value and improve focusing efficiency.

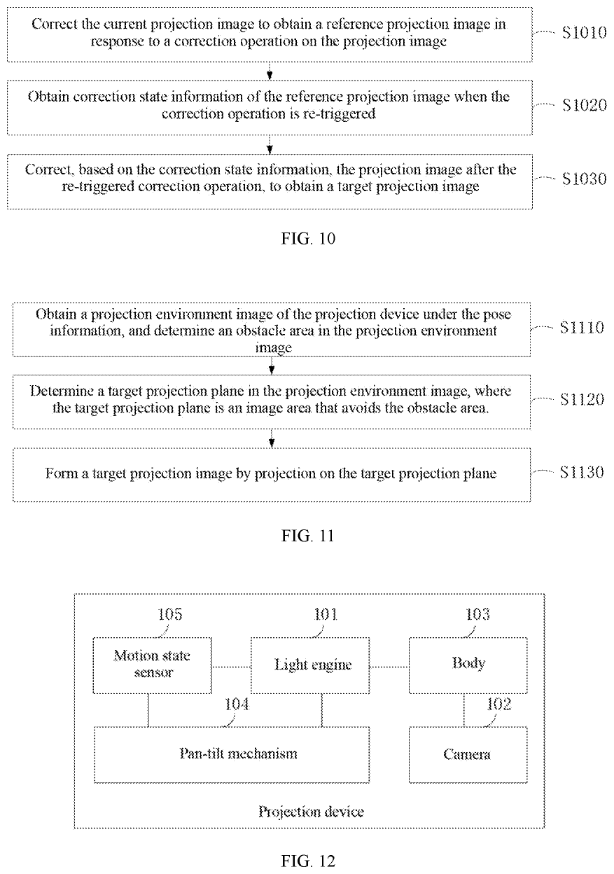

In practical applications, the projection image of the projection device can be corrected multiple times. In one example, as shown in FIG. 10, after S250 of correcting the projection image based on the adjusted target throw ratio, the method further includes:

S1010: Correct the current projection image to obtain a reference projection image in response to a correction operation on the projection image.

In an example, the projection device can form a projection image in an initial state and correct the projection image to obtain the corrected reference projection image in response to the correction operation on the projection image. The initial state may be a state where the projection device is powered on for the first time after a power outage, or a state where the projection device enters a wake-up state from a sleep mode.

For example, the correction operation may be triggered based on a user's adjustment operation or automatically triggered based on a state of the projection device. For example, the correction operation on the projection image is triggered when the body shakes.

S1020: Obtain correction state information of the reference projection image when the correction operation is re-triggered.

The re-triggered correction operation may be the same as or different from the previous correction operation.

In an optional example, the correction operation includes throw ratio correction and/or keystone correction.

In one example, the correction operation includes keystone correction, and a situation for the re-triggered correction operation includes adjusting the reference projection image, and re-triggering the keystone correction when a change in the projection angle and/or throw distance triggers the correction operation.

In one example, the correction operation includes throw ratio correction, and a situation for the re-triggered correction operation includes adjusting the reference projection image, and re-triggering the throw ratio correction when a change in the throw distance and/or projection angle triggers zooming.

In an example, after the projection device forms the reference projection image, when the correction operation is re-triggered, the projection device obtains pose information of the projection device that forms the reference projection image as the correction state information.

S1030: Correct, based on the correction state information, the projection image after the re-triggered correction operation, to obtain a target projection image.

In an example, after obtaining the correction state information of the projection device in case of the re-triggered correction operation, the projection device can correspondingly correct, based on the correction state information, the projection image after the re-triggered correction operation, to obtain the target projection image.

In the examples of the present application, the current projection image is corrected to obtain the reference projection image in response to the correction operation on the projection image, the correction state information of the reference projection image is obtained when the correction operation is re-triggered, and the projection image after the re-triggered correction operation is corrected based on the correction state information to obtain the target projection image. In the above method, the correction state information is determined based on the reference projection image obtained by the previous correction, and the projection image is corrected using the correction state information in case of the re-triggered correction operation, achieving re-correction based on a previous correction result. The use of the previous correction result in case of re-triggered correction can prevent a user-defined throw ratio from being forcibly reset and a previously avoided obstacle area from re-entering a frame, thereby improving the correction effect.

The projection angle in the correction state information includes pose information of the projection device. In one example, as shown in FIG. 11, S1030 of correcting, based on the correction state information, the projection image after the re-triggered correction operation, to obtain a target projection image includes:

S1110: Obtain a projection environment image of the projection device under the pose information, and determine an obstacle area in the projection environment image.

The pose information of the projection device includes a throw distance or pose data of the projection device. For example, the attitude data includes at least one of a side throw angle, a pitch angle, and a roll angle of the projection device.

In an example, the projection device can obtain the projection environment image under the pose information in the correction state information through an image capture device, and perform obstacle detection on the projection environment image to determine the obstacle area where obstacles exist in the projection environment image.

S1120: Determine a target projection area in the projection environment image. The target projection area is an image area that avoids the obstacle area.

In an example, after determining the obstacle area in the projection environment image, the projection device can avoid the obstacle area in the projection environment image to obtain the target projection area.

For example, the projection device can determine a non-obstacle area in the projection environment image that avoids the obstacle area, and determine a largest horizontal rectangular area in the non-obstacle area as the target projection area.

S1130: Form a target projection image by projection on the target projection area.

In an example, after obtaining the target projection area in the projection environment image, the projection device can adjust the pose information for projection on the target projection area to form the target projection image that matches the target projection area in position and size.

In the examples of the present application, the projection angle includes the pose information of the projection device, the projection environment image of the projection device under the pose information is obtained, the obstacle area in the projection environment image is determined, the target projection area is determined in the projection environment image, and the target projection image is formed by projection on the target projection area. The target projection area is the image area that avoids the obstacle area. In the above method, obstacles in the projection environment image are avoided to determine the target projection area, and the target projection image is formed by projection on the target projection area, thereby achieving obstacle avoidance projection, reducing the interference of obstacles on the projection image, and improving the projection effect.

In order to maintain an attitude of the projection device, in one example, before S210 of controlling the light engine and/or the body to perform adjustment motion in response to a received motion instruction, the method further includes:

driving the light engine and/or the body to perform the adjustment motion to a preset angle. The preset angle is a projection angle of the projection device before last power-off, or the preset angle is a pre-stored projection angle corresponding to a specific scenario.

Before the projection device is powered off or enters a sleep state, the current projection angle of the projection device is stored as the preset angle. The target scenario is used to represent a usage scenario of the projection device, such as a bedroom scenario or a living room scenario.

In an example, when the projection device is powered on for the first time after a power outage (i.e., turned on) or enters a wake-up state, the projection device can drive the light engine and/or the body of the projection device for the adjustment motion to a projection angle before the last power-off, e.g., the preset angle. The preset angle may alternatively be a pre-stored projection angle corresponding to the target scenario. For example, before obtaining a motion state of the projection device, the projection device in the living room scenario drives the light engine and/or the body of the projection device to perform pitch motion and/or horizontal motion to a projection angle corresponding to the living room scenario.

In the examples of the present application, the light engine and/or the body are driven to perform adjustment motion to the preset angle. The preset angle is the projection angle of the projection device before last power-off, or the preset angle is the pre-stored projection angle corresponding to the specific scenario. In the above method, the projection device can maintain the projection angle before the last power-off or match the projection angle with the specific scenario, thereby reducing user's redundant adjustment operations and improving the control efficiency of the projection device.

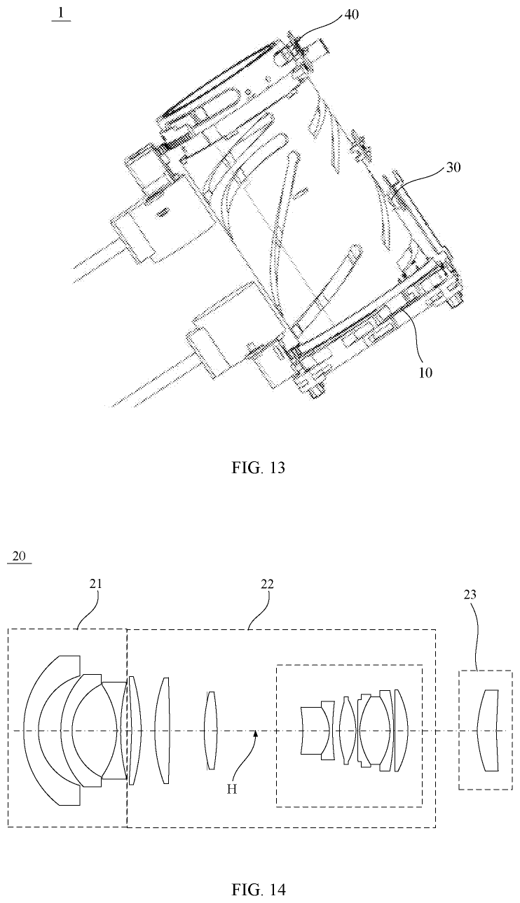

The present application further provides a projection device. As shown in FIG. 12, the projection device includes a light engine 101, a camera 102, a body 103, a pan-tilt mechanism 104, and a motion state sensor 105.

The pan-tilt mechanism 104 is rotatably connected to the light engine 101 and configured to drive the light engine 101 to perform adjustment motion. The adjustment motion includes at least pitch motion. The pan-tilt mechanism 104 is rotatably connected to the body 103 and configured to drive the body 103 to perform adjustment motion.

The motion state sensor 105 is connected to the light engine 101 and/or the pan-tilt mechanism 104 to obtain a motion state of the projection device.

The camera 102 is arranged on the body 103 and configured to obtain planar image data of a to-be-projected area.

The projection device is configured to determine a target projection area based on the planar image data when the motion state is detected as stopping motion, adjust a target throw ratio for a projection image based on the target projection area, and correct the projection image based on the adjusted target throw ratio.

In one example, the light engine 101 includes a projection lens 1, and a light source of the light engine 101 projects from the projection lens 1 to a target projection plane. As shown in FIG. 13 and FIG. 14, the projection lens 1 includes: a lens barrel 10, an optical lens set 20 located in the lens barrel 10, and a zoom detection assembly 30. The optical lens set 20 has a first optical axis H. The optical lens set 20 includes a zoom lens set 22 and a focus lens set 21 arranged along an extension direction of the first optical axis H, and both the zoom lens set 22 and the focus lens set 21 can slide (or are slidable) relative to the lens barrel 10 along the extension direction of the first optical axis H.

The zoom detection assembly 30 includes a zoom motion component and a zoom detection component (not separately shown). One of the zoom motion component and the zoom detection component is connected to the zoom lens set 22 to follow the movement of the zoom lens set 22 for zooming, and the other one is fixed relative to the lens barrel 10. The zoom detection component is configured to cooperate with the zoom motion component to detect a movement distance of the zoom lens set 22 relative to the lens barrel 10.

The lens barrel 10 provides a mounting space for the optical lens set 20. The zoom lens set 22 may include a lens holder and one or more lenses. The lenses are mounted on the lens holder, and the lens holder is slidably connected to the lens barrel 10 along the extension direction of the first optical axis H, thereby driving the lenses to slide along the extension direction of the first optical axis H. The lens barrel 10 has a front side and a rear side. The distance between the front side of the lens barrel 10 and an object to be photographed is relatively short, while the distance between the rear side of the lens barrel 10 and the object to be photographed is relatively long. The zoom lens set 22 can be used as a zoom set of the projection lens 1 and is located in the middle of the lens barrel 10. The zoom lens set 22 changes the focal length of the projection lens 1 by moving, thereby changing a viewing angle or image size, and obtaining an effect of zooming in or out.

It should be noted that, in the examples of the present application, one of the zoom motion component and the zoom detection component is arranged on the zoom lens set 22. The other one of the zoom motion component and the zoom detection component is fixedly arranged on the lens barrel 10, and when the projection lens 1 is zooming, the zoom motion component cooperates with the zoom detection component to detect a movement distance required by the zooming of the projection lens 1, so that the zoom lens set 22 can be directly driven to a desired adjustment position, thereby achieving a zooming function of the projection lens 1. In this example, the arrangement of the zoom detection assembly 30 on different optical assemblies can shorten the time required by the projection lens 1 in the zooming process and improve the zooming accuracy of the projection lens 1.

As shown in FIG. 14, in some examples of the present application, the optical lens set 20 further includes a fixed lens set 23 fixed to the lens barrel 10, and the fixed lens set 23 and the zoom lens set 22 are arranged along the extension direction of the first optical axis H. One of the zoom motion component and the zoom detection component is connected to the zoom lens set 22, and the other one is connected to the fixed lens set 23. The zoom detection component is configured to cooperate with the zoom motion component to detect a distance between the zoom lens set 22 and the fixed lens set 23.

The fixed lens set 23 can provide a setting basis for either the zoom motion component or the zoom detection component. The fixed lens set 23 is located on the rear side of the lens barrel 10 and can provide a basic focal power for the optical lens set 20, and the fixed lens set 23 remains fixed and can further provide a reference for the movement of the zoom lens set 22.

For example, the zoom detection component is a first magnet. The zoom motion component is a first sensor, and the first sensor is configured to sense a magnetic signal of the first magnet to detect the distance between the zoom lens set 22 and the fixed lens set 23.

The first sensor can sense a magnetic field strength of the first magnet. According to the principle of distance attenuation of the magnetic field, when the first magnet and the first sensor are at different opposite positions, the magnetic field strength of the first magnet, sensed by the first sensor, is different. One of the first magnet and the first sensor follows the zoom lens set 22 to move along the extension direction of the first optical axis H. The other one of the first magnet and the first sensor is fixed to a position of the fixed lens set 23. At this point, a mapping relationship can be established between the position of the fixed lens set 23 and the magnetic field strength sensed by the first sensor.

When the position of the first magnet moves, the magnetic field of the first magnet moves with the first magnet. At this point, the magnetic field strength sensed by the first sensor changes, and the zoom lens set 22 can be directly driven in the projection lens 1 to move to a position of a preset magnetic field strength sensed by the first sensor, thereby completing the zooming process of the projection lens 1 and capturing clear images. For example, the first sensor is a TMR sensor. The tunnel magneto resistance sensor has better temperature stability, higher sensitivity, lower power consumption, and better linearity. Therefore, the application of the TMR sensor further optimizes the zooming performance of the projection lens 1.

For example, the first magnet is a magnetic strip, that is, the first magnet is composed of multiple segments of magnetic blocks connected end to end. The first magnet has a plurality of N poles and a plurality of S poles, and the N poles and the S poles of the first magnet are alternately arranged along the extension direction of the first optical axis H, so that the magnetic field generated by the first magnet is of a periodic sine waveform. The first sensor senses the periodically changing magnetic field to measure the distance between the zoom lens set 22 and the fixed lens set 23 more accurately, and the periodically changing magnetic field can also effectively reduce external interference, thereby improving the zooming accuracy and stability of the projection lens 1. Through the magnetic field of the periodic sine waveform, the first sensor can not only accurately measure the distance to ensure the zooming stability and accuracy, but also maintain high sensitivity in complex environments to reduce errors and enable the projection lens 1 to present clear images at different focal lengths, thereby significantly improving the imaging quality of the projection lens 1.

As shown in FIGS. 13 and 14, the projection lens 1 in the projection device further includes a focus detection assembly 40 including a focus motion component and a focus detection component (not separately shown). One of the focus motion component and the focus detection component is connected to the focus lens set 21 and follows the movement of the focus lens set 21 for focusing, and the other one is fixed relative to the lens barrel 10. The focus detection component is configured to cooperate with the focus motion component to detect a movement distance of the focus lens set 21 relative to the lens barrel 10.

For example, the focus detection component is a second magnet. The focus motion component is a second sensor, and the second sensor is configured to sense a magnetic signal of the second magnet to detect the distance between the focus lens set 21 and the fixed lens set 23.

When the position of the second magnet moves, the magnetic field of the second magnet moves with the second magnet, and the magnetic field strength sensed by the second sensor changes accordingly. At this time, the focus lens set 21 can be directly driven in the projection lens 1 to move to a position of a preset magnetic field strength sensed by the second sensor, thereby completing a focusing process of the projection lens 1. For example, both the first sensor and the second sensor are TMR sensors. The tunnel magneto resistance sensors have better temperature stability, higher sensitivity, lower power consumption, and better linearity. Therefore, the application of the TMR sensors further optimizes the zooming and focusing performance of the projection lens 1.

It should be noted that the above projection device is configured to implement the control method for the projection device in any of the foregoing items. The specific content can be found in the foregoing examples and will not be repeated here.

It should be understood that, although the steps in the flowcharts of the examples as described above are displayed sequentially according to the instructions of arrows, these steps are not necessarily performed sequentially according to the sequence instructed by the arrows. Unless otherwise explicitly specified herein, these steps are not limited in a strict sequence, but may be executed in other sequences. Moreover, at least some of the steps in the flowchart of each example may include a plurality of steps or a plurality of stages. These steps or stages are not necessarily performed at the same time, but may be performed at different time. The steps or stages are not necessarily sequentially performed, but may be performed alternately with other steps or at least some of steps or stages of other steps.

Based on the same inventive concept, an example of the present application further provides a control apparatus for a projection device for implementing the foregoing control method for the projection device. The implementation solution provided by the apparatus to solve the problem is similar to the implementation solution described in the foregoing method. Therefore, the specific limitations in one or more examples of the control apparatus for the projection device, provided below, can refer to the limitations of the foregoing control method for the projection device. Details will not be repeated here.

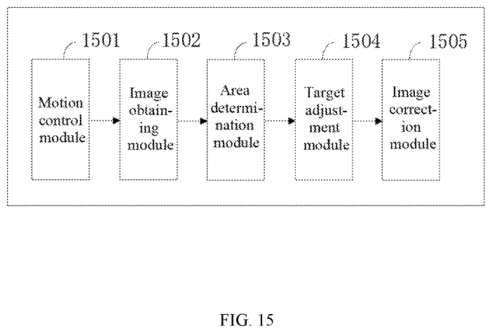

As shown in FIG. 15, a control apparatus for a projection device is provided, including: a motion control module 1501, an image obtaining module 1502, an area determination module 1503, a target adjustment module 1504, and an image correction module 1505.

The motion control module 1501 is configured to control a light engine and/or a body to perform adjustment motion in response to a received motion instruction. The adjustment motion includes at least pitch motion.

The image obtaining module 1502 is configured to obtain planar image data of a to-be-projected area through a camera during the motion of the light engine and/or the body.

The area determination module 1503 is configured to determine a target projection area based on the planar image data when a motion state of the projection device is detected as stopping motion.

The target adjustment module 1504 is configured to adjust a target throw ratio for a projection image based on the target projection area.

The image correction module 1505 is configured to correct the projection image based on the adjusted target throw ratio.

The various modules in the foregoing control apparatus for the projection device can be fully or partially implemented through software, hardware, and a combination thereof. The modules can be embedded in or independent of a processor in a computer device in a form of hardware, or stored in a memory of a computer device in a form of software, whereby the processor calls the modules to perform operations corresponding to the modules.

In an example, a computer-readable storage medium is provided, storing a computer program that, when executed by a processor, implements the steps of the control method for the projection device in any of the above items.

In an example, a computer program product is provided, including a computer program that, when executed by a processor, implements the steps of the control method for the projection device in any of the above items.

A person of ordinary skill in the art may understand that all or some of the processes in the methods of the foregoing examples may be implemented by a computer program instructing relevant hardware. The computer program may be stored in a non-volatile computer-readable storage medium. The computer program, when executed, may include the processes of the examples of the above methods. Any reference to the memory, the database, or other medium used in the examples provided in the present application may all include a non-volatile or volatile memory. The non-volatile memory may include a read-only memory (ROM), a magnetic tape, a floppy disk, a flash memory, an optical memory, a high-density embedded non-volatile memory, a resistive random access memory (ReRAM), a magnetoresistive random access memory (MRAM), a ferroelectric random access memory (FRAM), a phase change memory (PCM), a graphene memory, and the like. The volatile memory may be a random access memory (RAM), an external cache, or the like. As an illustration and not a limitation, the RAM may be in various forms, such as a static random access memory (SRAM) or a dynamic random access memory (DRAM). The database involved in each example provided in the present application may include at least one of a relational database and a non-relational database. The non-relational database may include, but is not limited to, a blockchain-based distributed database and the like, without limitation herein. The processor involved in each example provided in the present application may be a general-purpose processor, a central processing unit, a graphics processing unit, a digital signal processor, a programmable logic device, a data processing logic device based on quantum computing, and the like, but is not limited to this.

Technical features of the foregoing examples may be randomly combined. To make description concise, not all possible combinations of the technical features in the foregoing examples are described. However, the combinations of these technical features are considered as falling within the scope recorded by this specification provided that no conflict exists.

The foregoing examples show merely several implementations of the present application and are described in detail, which, however, are not to be construed as a limitation to the patent scope of the present application. It should be noted that a person of ordinary skill in the art may make variations and improvements without departing from the concept of the present application, and these variations and improvements all fall into the scope of protection of the present application. Therefore, the scope of protection of the present application should be subject to the appended claims.

What is claimed is:

1. A control method for a projection device, comprising:
controlling at least one of a light engine of the projection device or a body of the projection device to perform an adjustment motion in response to a received motion instruction, wherein the adjustment motion comprises at least a pitch motion;
obtaining planar image data of a to-be-projected area through a camera of the projection device during the motion of the at least one of the light engine or the body, wherein the light engine and the camera are arranged on the body;
determining a target projection area based on the planar image data in response to detecting that the adjustment motion has stopped;
adjusting a target throw ratio for a projection image based on the target projection area; and
correcting the projection image based on the adjusted target throw ratio.

2. The method of claim 1, wherein the determining the target projection area comprises:
determining a maximum projectable area based on the planar image data, wherein the maximum projectable area is one of a screen and an obstacle avoidance area; and
determining the maximum projectable area as the target projection area.

3. The method of claim 2, wherein when the maximum projectable area is the screen, the adjusting a target throw ratio comprises:
using a preset target ratio of the projection image to the screen as the target throw ratio, and adjusting the projection image within an area of the screen based on the target throw ratio.

4. The method of claim 2, wherein when the maximum projectable area is the obstacle avoidance area, an inscribed rectangle of the maximum projectable area is used as the target projection area; and
the adjusting a target throw ratio comprises:
using a preset target ratio of the projection image to the inscribed rectangle as the target throw ratio, and adjusting the projection image within an area of the inscribed rectangle based on the target throw ratio.

5. The method of claim 3, wherein the correcting the projection image comprises:
projecting a calibration pattern within the target projection area and obtaining position information of the calibration pattern; and
projecting the projection image into the target projection area based on the position information of the calibration pattern and the preset target ratio.

6. The method of claim 1, wherein before controlling the at least one of the light engine or the body to perform the adjustment motion in response to a received motion instruction, the method further comprises:
adjusting a throw ratio of the projection device to a maximum size achievable by a current projection image, and projecting the current projection image to the to-be-projected area.

7. The method of claim 1, wherein the light engine comprises a focus lens set and a zoom lens set, and the correcting the projection image based on the adjusted target throw ratio comprises at least one of:
controlling the focus lens set to move to a target focus position corresponding to the target throw ratio based on a preset focus mapping relationship between a throw ratio and a focus position; or
controlling the zoom lens set to move to a target zoom position corresponding to the target throw ratio based on a preset zoom mapping relationship between a throw ratio and a zoom position.

8. The method of claim 7, wherein the controlling the focus lens set to move to a target focus position corresponding to the target throw ratio comprises:
determining, based on a current position of the focus lens set and the target focus position, a focus movement direction of a focus drive mechanism associated with the focus lens set; and
controlling the focus drive mechanism to move towards the focus movement direction, and driving the focus lens set to move towards the target focus position.

9. The method of claim 7, wherein the light engine further comprises a focus detection assembly, and the target focus position is a position of the focus lens set when the focus detection assembly detects target detection data, the controlling the focus lens set to move to the target focus position corresponding to the target throw ratio further comprising:
obtaining a focus detection data deviation between current focus detection data of the focus detection assembly and the target detection data; and
determining that the focus lens set has moved to the target focus position when the focus detection data deviation is less than a preset detection deviation.

10. The method of claim 7, wherein the light engine further comprises a zoom detection assembly, and the target zoom position is a position of the zoom lens set when the zoom detection assembly reaches a target position, the controlling the zoom lens set to move to the target zoom position corresponding to the target throw ratio further comprising:
obtaining a zoom position deviation between a current position of the zoom detection assembly and the target position; and
determining that the zoom lens set has moved to the target zoom position when the zoom position deviation is less than a preset position deviation.

11. The method of claim 1, wherein after correcting the projection image based on the adjusted target throw ratio, the method further comprises:
obtaining at least one of:
a throw distance of the target projection area; or
a projection angle of the projection device;
obtaining a focus compensation value corresponding to at least one of the throw distance or the projection angle, based on a preset focus compensation mapping relationship, wherein the focus compensation mapping relationship defines a correspondence between the focus compensation value and at least one of the throw distance or the projection angle for a plurality of throw distances and/or projection angles; and
performing focus compensation on the projection image based on the focus compensation value.

12. The method of claim 11, wherein the obtaining the focus compensation value comprises:
determining a target focal length corresponding to at least one of the throw distance or the projection angle, based on the focus compensation mapping relationship; and
determining the focus compensation value based on a difference between a current focal length of the projection device and the target focal length.

13. The method of claim 1, wherein after correcting the projection image based on the adjusted target throw ratio, the method further comprises:
correcting a current projection image to obtain a reference projection image in response to a correction operation on the projection image;
obtaining correction state information of the reference projection image when the correction operation is re-triggered; and
correcting, based on the correction state information, the projection image after the re-triggered correction operation, to obtain a target projection image.

14. The method of claim 13, wherein the correction state information comprises a throw distance of the target projection area and a projection angle of the projection device, and the correction operation comprises at least one of throw ratio correction or keystone correction.

15. The method of claim 14, wherein the correction operation comprises keystone correction, and a situation for the re-triggered correction operation comprises:
adjusting the reference projection image, and re-triggering the keystone correction when a change in at least one of the projection angle or throw distance triggers the correction operation.

16. The method of claim 14, wherein the correction operation comprises throw ratio correction, and a situation for the re-triggered correction operation comprises:
adjusting the reference projection image, and re-triggering the throw ratio correction when a change in at least one of the throw distance or projection angle triggers the correction operation.

17. The method of claim 14, wherein the projection angle comprises pose information of the projection device, and the correcting the projection image comprises:
obtaining a projection environment image of the projection device under the pose information;
determining an obstacle area in the projection environment image;
determining the target projection area in the projection environment image, wherein the target projection area is an image area that avoids the obstacle area; and
forming a target projection image by projection on the target projection area.

18. The method of claim 1, wherein before controlling at least one of the light engine or the body to perform the adjustment motion in response to a received motion instruction, the method further comprises:
driving at least one of the light engine or the body to perform the adjustment motion to a preset angle, wherein the preset angle is at least one of:
a projection angle of the projection device before last power-off; or
a pre-stored projection angle corresponding to a specific scenario.

19. A projection device comprising:
a light engine;
a camera;
a body;
a pan-tilt mechanism; and
a motion state sensor, wherein:
the pan-tilt mechanism is:
rotatably connected to the light engine and configured to drive the light engine to perform an adjustment motion, wherein the adjustment motion comprises at least a pitch motion; or
rotatably connected to the body and configured to drive the body to perform the adjustment motion,
the motion state sensor is connected to at least one of the light engine or the pan-tilt mechanism to obtain a motion state of the projection device,
the camera is arranged on the body and configured to obtain planar image data of a to-be-projected area, and
the projection device is configured to determine a target projection area based on the planar image data in response to detecting that the adjustment motion has stopped, to adjust a target throw ratio for a projection image based on the target projection area, and to correct the projection image based on the adjusted target throw ratio.

20. The projection device of claim 19, wherein the light engine comprises a projection lens, and a light source of the light engine projects from the projection lens to a target projection plane, the projection lens comprising:
a lens barrel;
an optical lens set located in the lens barrel, wherein the optical lens set has a first optical axis, the optical lens set comprises a zoom lens set and a focus lens set arranged along an extension direction of the first optical axis, and both the zoom lens set and the focus lens set are slidable relative to the lens barrel along the extension direction of the first optical axis; and
a zoom detection assembly, comprising a zoom motion component and a zoom detection component, wherein one of the zoom motion component and the zoom detection component is connected to the zoom lens set to follow the movement of the zoom lens set, and the other one is fixed relative to the lens barrel, the zoom detection component being configured to cooperate with the zoom motion component to detect a movement distance of the zoom lens set relative to the lens barrel.
